(19) United States
(12) Patent Application Publication
(10) Pub. No.: US 2011/0239127 A1
(43) Pub. Date: Sep. 29, 2011

(54) CUSTOMIZING SYSTEM AND METHOD FOR CONVERTING DESKTOP APPLICATION INTO WEB APPLICATION

(75) Inventors: Xin MENG, Beijing (CN); Cailiang Song, Beijing (CN); Jingwei Shi, Beijing (CN); Lian Wang, Beijing (CN); Huifeng Liu, Beijing (CN); Xiaowei Liu, Beijing (CN)

(73) Assignee: NEC (China) Co., Ltd., Beijing (CN)

(21) Appl. No.: 13/012,419

(22) Filed: Jan. 24, 2011

(30) Foreign Application Priority Data
Mar. 23, 2010 (CN) 201010132466.9

(51) Int. Cl. G06F 3/048

(52) U.S. Cl. 715/747

(57) ABSTRACT

The present invention provides a customizing system and a customizing method for converting a desktop application into a web application. A required processing logic may be added by locating an interface element which is needed to be modified, and modifying a callback function of the interface element (interface description data), so as to implement user's operations on local data by a web application. When a user operates on the modified interface element at a browser side, the added processing logic automatically converts the user's operation to a plurality of operations, so that the user may feel that he is operating on a local file at the browser side, rather than a remote file at a server side. The present invention may implement complex webpage function customization, and thus may implement remote operations on local data.

### FIELD OF INVENTION

The present invention relates to a field of computer application mitigation, and particularly, relates to a customizing system and a customizing method for converting a desktop application into a web application.

### DESCRIPTION OF PRIOR ART

With the development of cloud computing and the Internet, people increasingly prefer to access services anytime and anywhere. However, a existing large number of desktop applications (a stand-alone application or a client-server version of application) require that a user must firstly install a client before corresponding operations may be performed, rather than providing services anytime and anywhere. If the existing system is discarded and a browser-server version of system which has the same set of functions is re-developed, the development costs are too high, and cause a waste of the original system. Therefore, a set of highly efficient desktop application migration schemes is desirable.

Here, the meaning of the “desktop application migration” is that the existing desktop applications and resources thereof are used for completing their web applications with a little of development amount by means of migration. Interfaces and functions of the web applications are basically the same as those of the existing desktop applications.

The meaning of the “migration” is that the existing desktop applications are run and their interfaces are re-drawn to be presented to the user in a form of webpage or other forms which may present by other network clients; after the user performs an operation on the webpage, the operation is presented on the desktop application, so as to complete a corresponding function; then an updated interface is re-drawn and presented to the user. Thus, developers may develop web applications in a short time without considering function implementation details, such as data access, logic flows and algorithm implementations, of the desktop applications.

Since after migration, no matter using what kind of migration method, the desktop application still runs at the server side, the web application corresponding to the desktop application which does not support web functions can also only operate data at the server side. However, users usually have strong requirement to operate their local data at the browser side rather than the server data. For example:
“Print” function:
   Original function: Printing a file at the server side (by a printer connected to the desktop application at the server side)
   Expected function: Printing a file in a computing device at the user side
“Open” function:
   Original function: Opening the file at the server side (by the desktop application in the server)
   Expected function: Opening the file in the computing device at the user side (by uploading the file to the server side and opening it by the desktop application)
“Save” function:
   Original function: Saving at the server side
   Expected function: Saving in the computing device at the user side

The Chinese patent application CN 1289093A discloses a method and a system of dynamically adding new functions for a world-wide-web webpage. The method mainly comprises steps of: receiving a webpage from a web server; adding a new URL in the webpage; sending the new webpage to a web browser; processing the server to realize corresponding new functions based on the URL sent from the web browser. This application discloses a particular instance for adding a translation function to the webpage. However, this application can only add a few simple functions to the webpage, since parameter descriptions of URL cannot contain complex information, e.g. file flows etc. Further, this application cannot implement functions at the browser side, e.g. creating file selecting box, uploading files etc. Therefore, the method cannot solve a problem of operating on remote data by the web application after migration.

In order to solve the above problem, we must find a system and a method for customizing the web application, which may customize functions of the web application and add functions to the web application.

### SUMMARY OF THE INVENTION

In order to overcome the above disadvantages in the prior art, the present invention provides a customizing system and a customizing method for converting a desktop application into a web application. A required processing logic may be added by locating an interface element which is needed to be modified, and modifying a callback function of the interface element (interface description data), so as to implement user's operations on local data by a web application. When a user operates on the modified interface element at a browser side, the added processing logic automatically converts the user's operation to a plurality of operations, so that the user may feel that he is operating on a local file at the browser side, rather than a remote file at a server side. The present invention may implement complex webpage function customization, and thus may implement remote operations on local data. For example, when the user clicks to a [OPEN] button/menu item, this operation may be converted to an operation of popping up a window at the browser side so as to allow the user to select the local file at the browser side, uploading the selected file by the user to the server, and at the same time, transmitting to the server action description data indicating the desktop application at the server side to open the uploaded file at the server side, so that the user may feel that he is opening the local file at the browser side, rather than the remote file at the server side.

According to a first aspect of the present invention, a server is provided. The server comprises a desktop application for being operated correspondingly based on a function to be customized, to return a corresponding output; an interface information dumping unit for dumping interface information for a window returned by the desktop application and organizing the interface information into interface description data; and a function customizing unit for locating an interface element to be modified in the interface description data, and modifying and/or adding a processing logic based on a desired function to achieve function customization.

Preferably, the processing logic may be used for automatically converting an operation by a user at a browser side into a series of operations consisting of local operations and/or remote operations, so that the user is able to access and/or operate a local file at the browser side by means of a web application.

Preferably, the processing logic may be an executable script.

According to a second aspect of the present invention, a function customizing method for converting a desktop application into a web application is provided. The method may comprise: correspondingly operating the desktop application to return a corresponding output based on a function to be customized; dumping interface information for a window returned by the desktop application and organizing the interface information into interface description data; and locating an interface element to be modified in the interface description data, and modifying and/or adding a processing logic based on a desired function to achieve function customization.

Preferably, the processing logic may be used for automatically converting an operation by a user at a browser side into a series of operations consisting of local operations and/or remote operations, so that the user is able to access and/or operate a local file at the browser side by means of the web application.

Preferably, the processing logic may be an executable script.

According to a third aspect of the present invention, a browser is provided. The browser may comprise: a web application for providing an operation page which includes at least one interface element operable by a user; and an operation converting unit for, when an interface element of the web application is operated, automatically converting an operation by the user at the browser side into a series of operations consisting of local operations and/or remote operations, so that the user is able to access and/or operate a local file at the browser side by means of the web application.

Preferably, the operation converting unit may generate an operation request based on the remote operations, wherein the operation request may contain action description data. The browser may further comprise a sending unit for sending the operation request to a server, and when a response returned by the server is received, the operation converting unit may process the response returned by the server based on the local operations.

More preferably, the operation converting unit may firstly, based on the local operations, obtain essential information and/or parameters necessary for subsequent operations, before generating the operation request based on the remote operations.

According to a fourth aspect of the present invention, a server is provided. The server comprises: a request parsing unit for parsing an operation request for a desktop application from a browser to obtain action description data; and an action replaying unit for driving the desktop application based on the action description data to replay operations for the desktop application, and sending an output returned by the desktop application to the browser as a response to the operation request.

According to a fifth aspect of the present invention, a customizing method for a web application mitigated from a desktop application is provided. The method comprises: automatically converting an operation by a user at a browser side into a series of operations consisting of local operations and/or remote operations when an interface element of the web application is operated, so that the user is able to access and/or operate a local file at the browser side by means of the web application.

Preferably, the customizing method for a web application mitigated from a desktop application according to claim 11 may further comprises: generating an operation request based on the remote operations, wherein the operation request contains action description data; sending the operation request to a server; and when a response returned by the server is received, processing the response returned by the server based on the local operations.

More Preferably, the customizing method for a web application mitigated from a desktop application may further comprise, before the step of generating the operation request, obtaining essential information and/or parameters necessary for subsequent operations, based on the local operations.

Preferably, when the operation request is received from the browser, the server may parse the operation request to obtain the action description data; drive the desktop application based on the action description data to replay operations for the desktop application; and send an output returned by the desktop application to the browser as a response to the operation request.

Compared to the most related prior art, the advantages of the present invention at least comprise:
the present invention may implement complex webpage function customization, and thus may implement remote operations on local data.

### BRIEF DESCRIPTION OF THE DRAWINGS

The above and other objects, features and advantages of the present invention will be more apparent by descriptions on embodiments of the present invention with reference to the drawings, in which:

FIG. 1 shows an illustrative structure block diagram of a server 200 for implementing a function customization;

FIG. 2 shows illustrative structure block diagrams of the server 200 and a browser 100 which implement a customized function;

FIG. 3 shows an instance schematic view for illustrating a function customization process;

FIG. 4 shows an operation flow between the browser 100 and the server 200 which implement a customized [OPEN] function;

FIG. 5 shows an operation flow between the browser 100 and the server 200 which implement a customized [PRINT] function;

FIG. 6 shows an operation flow between the browser 100 and the server 200 which implement a customized [SAVE] function; and

FIG. 7 shows an operation flow between the browser 100 and the server 200 which implement a customized [SAVE AS] function.

The same reference numbers in the drawings represent the related units, so as to show their relativities.

### DETAILED DESCRIPTION OF PREFERRED EMBODIMENTS

Hereinafter, the present invention will be further described in detail by referring to the embodiments as shown in the drawings. However, it should be understood that the descriptions are only Illustrative but do not make any limitations on the scope of the present invention. Additionally, the following explanations omit descriptions on well-known structures and techniques so as to avoid obscuring concepts of the present invention unnecessarily.

FIG. 1 shows an illustrative structure block diagram of a server 200 for implementing a function customization. According to the present invention, a required processing logic may be added by locating an interface element which is needed to be modified, and modifying a callback function of the interface element (interface description data), so as to implement the function customization.

As shown in FIG. 1, the sever 200 may comprise a desktop application 230, an interface information dumping unit 240 and a function customizing unit 250 which are installed at the server 200 side.

The desktop application 230 may be operated correspondingly based on a function to be customized, to enable the desktop application 230 to return a corresponding output such as a window, response information etc.

The interface information dumping unit 240 may dump interface information for each window returned from the desktop application 230, and organize the interface information into interface description data. The interface description data may use descriptive language formats such as XML, HTML, WML, etc. The present invention does not make any limitations on this point.

The function customizing unit 250 may locate an interface element to be modified in the interface description data, and modify and/or add a processing logic based on a desired function to achieve function customization. Here, the processing logic may be an executable script.

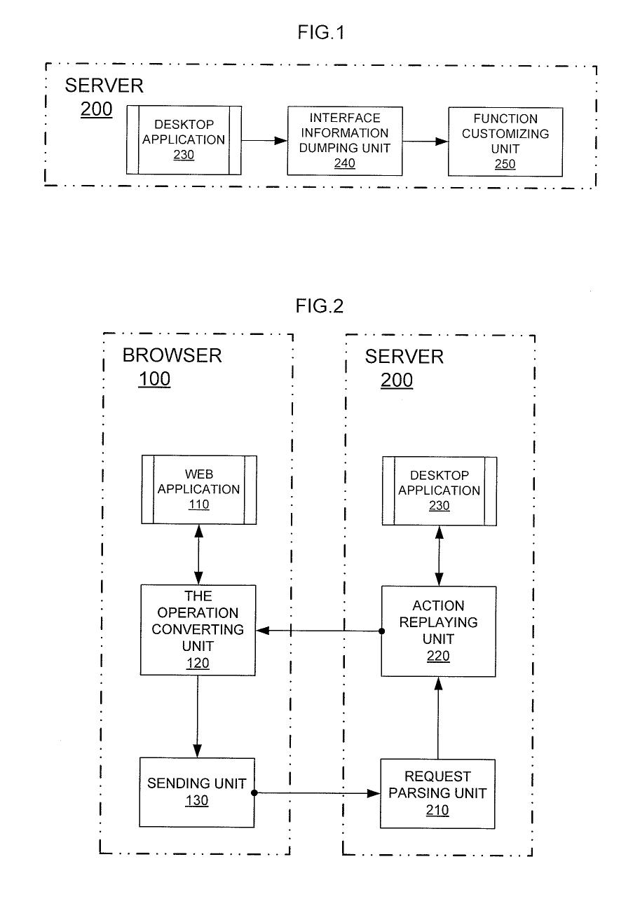

FIG. 2 shows illustrative structure block diagrams of the server 200 and a browser 100 which implement a customized function. When the user operates on the modified interface element at the browser side 100, an operation converting unit 120 may automatically convert the use's operation to a plurality of operations, so that the user may feel that he is operating on a local file at the browser 100 side, rather than a remote file at a server 200 side. Actually, in most situations, the user still operates on the remote file at the server 200 side.

As shown in FIG. 2, the browser 100 may comprise a web application 110, the operation converting unit 120 and a sending unit 130.

The web application 110 may provide an operation page for the user. The user may operate on the interface element of the web application 110 presented on the browser 100.

The operation converting unit 120 may be implemented by the processing logic added by the function customizing unit 250. When the user operates on the modified interface element, the operation converting unit 120 may automatically convert the user's operation to a plurality of operations to form an operation request. The operation request contains action description data which comprise information related to actions, e.g. which action is performed on which interface element, essential parameters for performing the action etc.

The operation converting unit 120 may further receive a response to the operation request from the server 200, and drive the local operation at the browser 100 side, so as to enable the user to feel that he is operating on the local file at the browser 100 side, rather than a remote file at a server 200 side. Actually, in most situations, the user still operates on the remote file at the server 200 side.

The sending unit 130 may be used for sending the operation request from the operation converting unit 120 to the server 200, i.e., a request parsing unit 210.

The server 200 may comprise the request parsing unit 210, an action replaying unit 220 and the desktop application 230.

The request parsing unit 210 may parse the operation request from the browser 100 to obtain action description data contained in the operation request.

The action replaying unit 220 may convert the action description data parsed by the request parsing unit 210 to a command for the desktop application 230, and drive the desktop application 230 to perform a same or similar operation which may reflect the user's operation on the browser 100 (remote).

Furthermore, the action replaying unit 220 may receive all of data returned from the desktop application 230 as the response to the operation request from the browser 100, and transmit the response to the browser 100, i.e., the operation converting unit 120.

Hereinafter, the customizing system and method for converting the desktop application to the web application will be described in detail in connection with particular function customization instances.

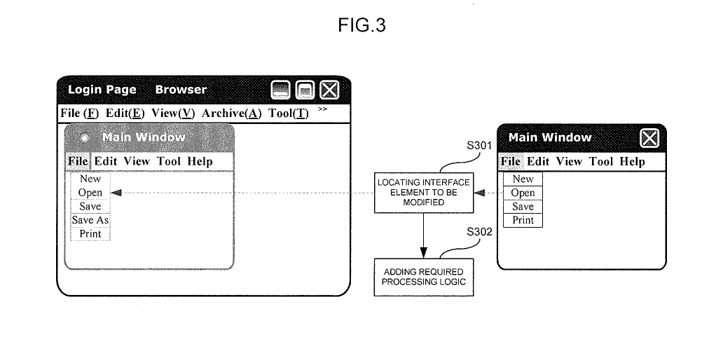

FIG. 3 shows an instance schematic view for illustrating a function customization process.

As shown in FIG. 3, the interface of the desktop application 230 on the server 200 is illustrated on the right of FIG. 3, which is in a main window currently. The window on the left of FIG. 3 illustrates corresponding page to be displayed on the browser 100.

The migration method from the desktop application to the web application may be implemented by referring to any of known methods.

For the purpose of illustration, a menu item “[OPEN]” is taken as an example. Firstly, in step S301, the function customizing unit 250 locates the interface element to be modified, i.e. the menu item “[OPEN]”, in the interface description data which are obtained from the interface information dumping unit 240. For example, the location may be performed by an Xpath element as follows:

Form[@title=“DesktopAP”]/menuitem[@text=“File”]/menuitem[@text=“Open”].

Then, in step S302, the function customizing unit 250 may modify a callback function (interface description data) of the menu item “[OPEN]” to the processing logic which may implement flows as follows: popping up an open window at the browser side 100 when the user clicks the menu item “[OPEN]” on the web application 110, so as to allow the user to select the local file at the browser 100; uploading the user selected file to the server 200, and at the same time, sending to the server 200 the action description data indicating the desktop application at the server 200 side to open the uploaded file at the server 200 side; and returning to the web application 110 an open interface when the server 200 returns the file to the open interface, so as to present the file in a form of the web application 110 to the user.

Similarly, the function customizing unit 250 may perform interface description data modification operations on any other of functions to be customized, so as to implement the expected customization functions. For example, the menu items “[PRINT]”, “[SAVE]”, etc. as illustrated in FIG. 3.

On the other hand, when the user wants to add new functions to the web application 110, the function customizing unit 250 may also add corresponding interface elements and interface description data, so as to implement the expected customization functions. For example, the menu item “[SAVE AS]”, etc.

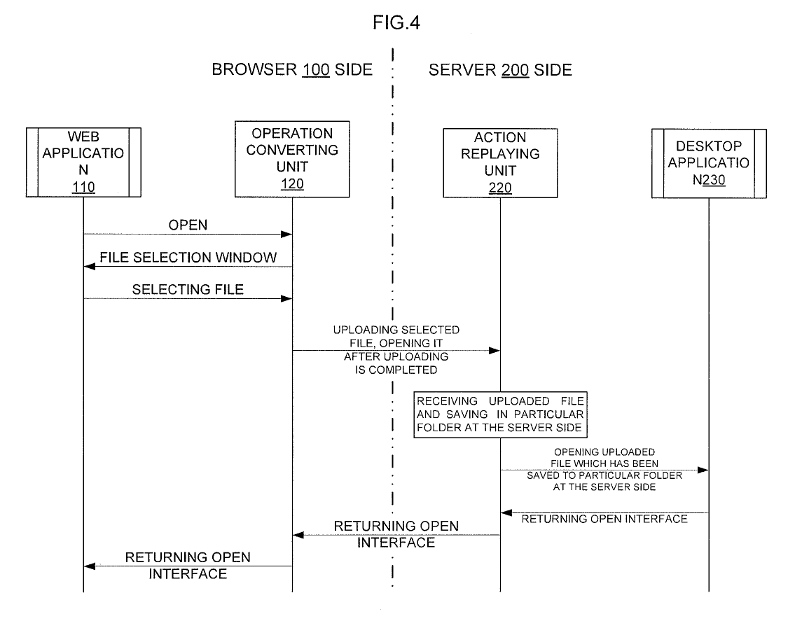

FIG. 4 shows an operation flow between the browser 100 and the server 200 which implement the customized [OPEN] function.

When the user clicks the menu item “[OPEN]” function on the page of the web application 110, the web application 110 sends an “open” instruction to the operation converting unit 120. Different from the prior art, the operation converting unit 120 does not generate an operation request containing the “open” action description data immediately. Instead, the operation converting unit 120 pops up a file selection window on the page of the web application 110, prompting the user to select a file to be open. The user operates on the file selection window, selects the file to be open, and returns to the operation converting unit 120 through the page of the web application 110. At this time, the operation converting unit 120 generates operation requests containing the action description data as follows: 1) uploading the selected file, 2) opening the file after the uploading is completed. The above action description data may be sent to the action replaying unit 220 through the sending unit 130 and the request parsing unit 210.

Different from the prior art, after the action replaying unit 220 receives the above action description data, the action replaying unit 220 firstly receives the file uploaded at the browser 100 side, and saves the received file to a particular folder at the server 200 side (e.g. a temp folder), i.e. the above action description data 1) has been completed. Then, the action replaying unit 220 indicates the desktop application 230 installed at the server 200 side to complete the open operation. It should be noted that at this time, the desktop application 230 may be indicated to open the uploaded file which has been saved in the particular folder at the server 200 side, i.e., the above action description data 2) has been completed. The desktop application 230 opens the uploaded file which has been saved in the particular folder at the server 200 side, and returns the open interface to the action replaying unit 220. At this time, the action replaying unit 220 has already replayed the operation similar with the user's operation at the browser 100 side. The action replaying unit 220 returns the open interface to the browser 100, i.e., the operation converting unit 120.

After the operation converting unit 120 receives the open interface returned from the receiver 200, i.e. the action replaying unit 220, the operation converting unit 120 returns the open interface to the web application 110. The open interface is presented to the user by the web application 110. Thus, the user may feel that he has opened the local file at the browser 100 side by the web application 110.

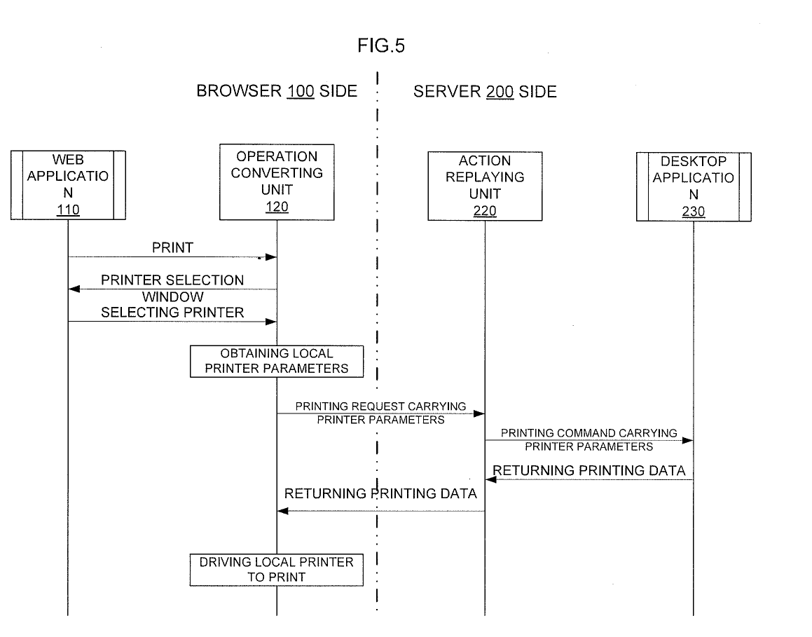

FIG. 5 shows an operation flow between the browser 100 and the server 200 which implement the customized [PRINT] function.

When the user clicks the menu item “[PRINT]” function on the page of the web application 110, the web application 110 sends a “print” instruction to the operation converting unit 120. Different from the prior art, the operation converting unit 120 does not generate an operation request containing the “print” action description data immediately. Instead, the operation converting unit 120 pops up a printer selection window on the page of the web application 110, prompting the user to select a printer to be used. The user operates on the printer selection window, selects the printer to be used, and returns to the operation converting unit 120 through the page of the web application 110. The operation converting unit 120 obtains parameters of a local printer according to the selection of the user. At this time, the operation converting unit 120 generates operation requests containing the action description data as follows: a printing request carrying the printer parameters. The above action description data may be sent to the action replaying unit 220 through the sending unit 130 and the request parsing unit 210.

After the action replaying unit 220 receives the above action description data, the action replaying unit 220 sends out the printing command carrying the printer parameters of a remote printer at the browser 100 side to the desktop application 230 installed at the server 200 side. The desktop application 230 generates printing data based on the printer parameters of the remote printer at the browser 100 side, and returns to the action replaying unit 220. At this time, the action replaying unit 220 has already replayed the operation similar with the user's operation at the browser 100 side. The action replaying unit 220 returns the printing data to the browser 100, i.e., the operation converting unit 120.

After the operation converting unit 120 receives the printing data returned from the receiver 200, i.e. the action replaying unit 220, the operation converting unit 120 drives the local printer to print. Thus, the user may feel that he has printed the local file at the browser 100 side on the local printer by the web application 110.

The above concerns the printing process in a case where the file has been opened, a case where the file has not been opened yet may be regarded as integrated operations of “open” operation, “print” operation and “close” operation. The “open” operation and the “print” operation may be performed in an order as described in FIGS. 4 and 5. The “close” operation is not required to be customized, and may still operate according to the prior art. Or, the “open” operation and the “print” operation may also be performed miscellaneously as described in FIGS. 4 and 5. For example, the file selection window may be popped up firstly to prompt the user to select a file; then the printer selection window may be popped up to prompt the user to select a printer; after the printer parameters are obtained, the operation request is sent, which may contain the action description data as follows: 1) uploading the selected file, 2) opening the file after the uploading is completed, 3) the printing request carrying the printer parameters; after the server completes the above actions 1)˜3), the printing data may be returned; the printing may be performed on the local printer of the browser; finally, the “close” operation may be performed according to the prior art. Or, the “open” operation, “print” operation and “close” operation may also be performed miscellaneously. For example, the file selection window may be popped up firstly to prompt the user to select a file; then the printer selection window may be popped up to prompt the user to select a printer; after the printer parameters are obtained, the operation request is sent, which may contain the action description data as follows: 1) uploading the selected file, 2) opening the file after the uploading is completed, 3) the printing request carrying the printer parameters, and 4) closing the file; after the server completes the above actions 1)˜4), the printing data may be returned; the printing may be performed on the local printer of the browser;

Similarly, various customization functions as described in the description may be performed serially or miscellaneously one another, and may also be performed serially or miscellaneously with various implemented functions in the prior art. The skilled in the art may complete these functions on demand. These serial or miscellaneous operations do not depart from the spirit and scope of the present invention.

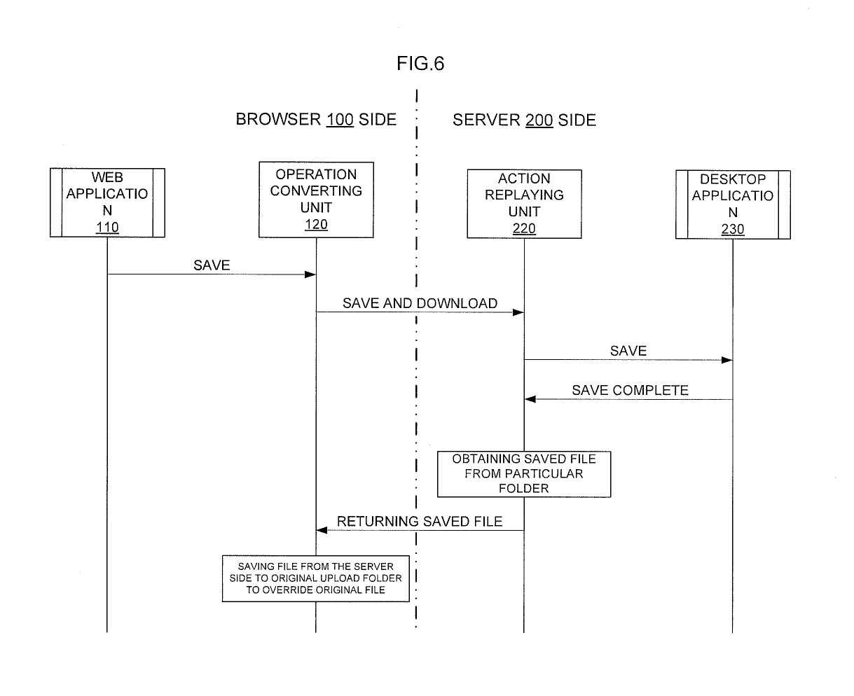

FIG. 6 shows an operation flow between the browser 100 and the server 200 which implement the customized [SAVE] function.

When the user clicks the menu item “[SAVE]” function on the page of the web application 110, the web application 110 sends a “save” instruction to the operation converting unit 120. Different from the prior art, the operation converting unit 120 generates operation requests containing the action description data as follows: 1) saving the current file, 2) downloading the file after the saving is completed. The above action description data may be sent to the action replaying unit 220 through the sending unit 130 and the request parsing unit 210.

Different from the prior art, after the action replaying unit 220 receives the above action description data, the action replaying unit 220 firstly instructs the desktop application 230 installed at the server 200 side to complete the save operation. It should be noted that at this time, the desktop application 230 may be actually indicated to save the current file to a particular folder at the server 200 side, i.e., the above action description data 1) has been completed. After the desktop application 230 returns a response to save complete, the saved file is obtained from the particular folder at the server 200 side, i.e., the above action description data 2) has been completed. At this time, the action replaying unit 220 has already replayed the operation similar with the user's operation at the browser 100 side. The action replaying unit 220 returns the open interface to the browser 100, i.e., the operation converting unit 120.

After the operation converting unit 120 receives the stored file returned from the receiver 200, i.e. the action replaying unit 220, the operation converting unit 120 saves the file from the server 200 to an original upload folder (which is a folder designated by the user when the [OPEN] operation is performed) to override the original file. Thus, the user may feel that he has saved the local file at the browser 100 side by the web application 110.

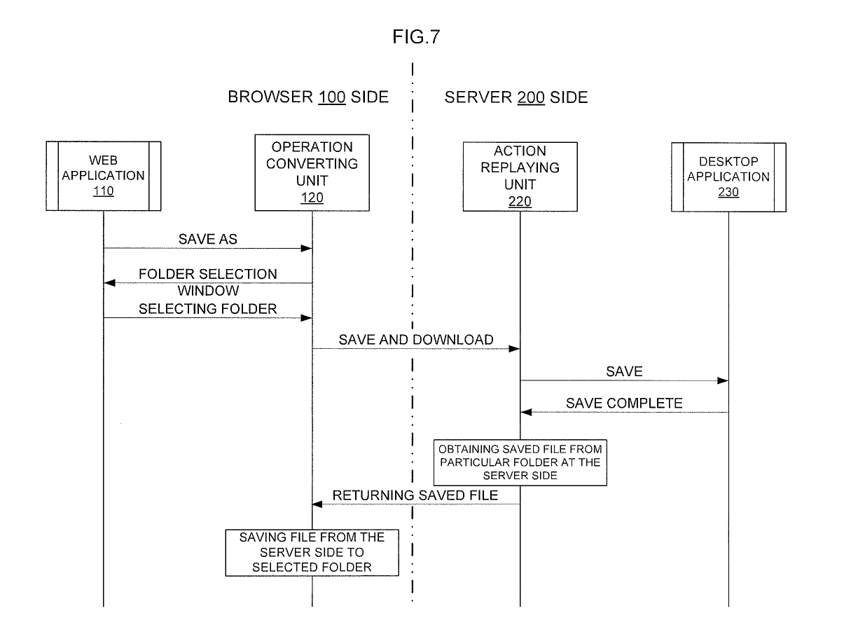

FIG. 7 shows an operation flow between the browser 100 and the server 200 which implement the customized [SAVE AS] function.

When the user clicks the menu item “[SAVE AS]” function on the page of the web application 110, the web application 110 sends a “save as” instruction to the operation converting unit 120. As shown in FIG. 3, the desktop application 230 does not have a menu item “[SAVE AS]”, this customization function actually being a newly added function. The operation converting unit 120 does not generate (actually also cannot generate) an operation request containing the “save as” action description data immediately. Instead, the operation converting unit 120 pops up a folder selection window on the page of the web application 110, prompting the user to select a folder to save files. The user operates on the folder selection window to select the folder to save files, and returns the selected folder to the operation converting unit 120 through the page of the web application 110. At this time, the operation converting unit 120 generates operation requests containing the action description data as follows: 1) saving the current file, 2) downloading the file after the saving is completed, which are actually the same as those for the operation requests of the menu item “[SAVE]”. The above action description data may be sent to the action replaying unit 220 through the sending unit 130 and the request parsing unit 210.

After the action replaying unit 220 receives the above action description data, the action replaying unit 220 firstly instructs the desktop application 230 installed at the server 200 side to complete the save operation. It should be noted that at this time, the desktop application 230 may be actually indicated to save the current file to a particular folder at the server 200 side, i.e., the above action description data 1) has been completed. After the desktop application 230 returns a response to save complete, the saved file is obtained from the particular folder at the server 200 side, i.e., the above action description data 2) has been completed. At this time, the action replaying unit 220 has already replayed the operation similar with the user's operation at the browser 100 side. The action replaying unit 220 returns the open interface to the browser 100, i.e., the operation converting unit 120. Actually, the above operations of the action replaying unit 220 are actually the same as those for the operation requests of the menu item “[SAVE]”.

After the operation converting unit 120 receives the stored file returned from the receiver 200, i.e. the action replaying unit 220, the operation converting unit 120 saves the file from the server 200 to the user selected folder. Thus, the user may feel that he has saved as the local file at the browser 100 side by the web application 110.

Further configurations of the disclosed invention embodiment comprise software programs for the steps and operations which are first described briefly and then elaborated in the method embodiments. More particularly, the computer program product is an embodiment having computer-readable medium encoded thereon computer program logic, which provides relevant operations when running on a computing device. While being executed on at least one processor of a computing system, the computer program logic causes the processor to perform the operations (steps) of the embodiments. Such configuration of the present invention is typically provided as software, code and/or other data structure provided or encoded on a computer-readable medium, such as optical medium (e.g., CD-ROM), flexible or hard disk, or other types of mediums, such as firmware or microcode on one or more ROM, RAM or PROM chips, or application specific integrated chip (ASIC), or downloadable software images, shared database in one or more modules. Such configuration as software or firmware can be installed on the computing device so as to cause one or more processors in the computing device to implement the embodiments of the present invention. Software processes operated with, for example, a group of data communication devices or computing devices in other entities can provide the system of the present invention. The system of the present invention can also be several software processes distributed over a number of data communication devices, or all software processes running on a group of a miniature dedicated computers, or all software processes running on a single computer.

It is noted that, strictly speaking, the embodiments of the present invention can be implemented in software program, software and hardware on a data communication device, or separate software and/or separate circuit.

The present invention has been described above with reference to the preferred embodiments thereof. It should be understood that various modifications, alternations and additions can be made by those who skilled in the art without departing from the spirits and scope of the present invention. Therefore, the scope of the present invention is not limited to the above particular embodiments but only defined by the claims as attached.

What is claimed is:

1. A server, comprising:
a desktop application for being operated correspondingly based on a function to be customized, to return a corresponding output;
an interface information dumping unit for dumping interface information for a window returned by the desktop application and organizing the interface information into interface description data; and
a function customizing unit for locating an interface element to be modified in the interface description data, and modifying and/or adding a processing logic based on a desired function to achieve function customization.

2. The server according to claim 1, wherein
the processing logic is for automatically converting an operation by a user at a browser side into a series of operations consisting of local operations and/or remote operations, so that the user is able to access and/or operate a local file at the browser side by means of a web application.

3. The server according to claim 1, wherein
the processing logic is an executable script.

4. The server according to claim 2, wherein
the processing logic is an executable script.

5. The server according to claim 1, further comprising:
a request parsing unit for parsing an operation request for a desktop application from a browser to obtain action description data; and
an action replaying unit for driving the desktop application based on the action description data to replay operations for the desktop application, and sending an output returned by the desktop application to the browser as a response to the operation request.

6. A browser, comprising:
a web application for providing an operation page which includes at least one interface element operable by a user; and
an operation converting unit for, when an interface element of the web application is operated, automatically converting an operation by the user at the browser side into a series of operations consisting of local operations and/or remote operations, so that the user is able to access and/or operate a local file at the browser side by means of the web application.

7. The browser according to claim 6, wherein
the operation converting unit generates an operation request based on the remote operations, wherein the operation request contains action description data,
the browser further comprises a sending unit for sending the operation request to a server, and
when a response returned by the server is received, the operation converting unit processes the response returned by the server based on the local operations.

8. The browser according to claim 6, wherein
before generating the operation request based on the remote operations, the operation converting unit firstly, based on the local operations, obtains essential information and/or parameters necessary for subsequent operations.

9. A customizing method for a web application mitigated from a desktop application, comprising:
when an interface element of the web application is operated, automatically converting an operation by a user at a browser side into a series of operations consisting of local operations and/or remote operations, so that the user is able to access and/or operate a local file at the browser side by means of the web application.

10. The customizing method for a web application mitigated from a desktop application according to claim 9, further comprising:
generating an operation request based on the remote operations, wherein the operation request contains action description data;
sending the operation request to a server; and
when a response returned by the server is received, processing the response returned by the server based on the local operations.

11. The customizing method for a web application mitigated from a desktop application according to claim 10, before the step of generating the operation request, further comprising:
based on the local operations, obtaining essential information and/or parameters necessary for subsequent operations.

12. The customizing method for a web application mitigated from a desktop application according to claim 10, wherein
when the operation request is received from the browser; the server
parsing the operation request to obtain the action description data;
driving the desktop application based on the action description data to replay operations for the desktop application; and
sending an output returned by the desktop application to the browser as a response to the operation request.

13. The customizing method for a web application mitigated from a desktop application according to claim 11, wherein
when the operation request is received from the browser, the server
parsing the operation request to obtain the action description data;
driving the desktop application based on the action description data to replay operations for the desktop application; and
sending an output returned by the desktop application to the browser as a response to the operation request.
